(19) United States
(12) Patent Application Publication
(10) Pub. No.: US 2011/0005688 A1
(43) Pub. Date: Jan. 13, 2011

(54) STRUCTURE OF CUTTING OPENING OF ADHESIVE TAPE DISPENSER

(76) Inventor: CHI-TSAI CHANG, Taichung City (TW)

Correspondence Address: LEONG C. LEI, PMB # 1008, 1839 YGNACIO VALLEY ROAD, WALNUT CREEK, CA, 94598, US

(21) Appl. No.: 12/498,382

(22) Filed: Jul. 7, 2009

(51) Int. Cl. B32B 38/04

(52) U.S. Cl. 156/523

(57) ABSTRACT

An adhesive tape dispenser includes a top forming a cutting opening. The cutting opening has an end forming a pivotal joint holed seat to pivotally couple a cutter that also serves as a cover. The pivotal joint holed seat has a bottom from which an extension board extends to a middle portion of the cutting opening so that a free end of the extension board defines an enlarged reception slot with respect to an opposite end of the cutting opening for withdrawal of adhesive tape, whereby a segment of the adhesive tape is adhesively attached to a flange surface under the cutter and an end face of the extension board in a stretched form. After the adhesive tape is cut off, the segment of the adhesive tape can be synchronously curved and received into the slot to thereby facilitate the withdrawal and cutting and subsequent reception of the adhesive tape.

### TECHNICAL FIELD OF THE INVENTION

The present invention generally relates to an improved structure of a cutting opening of an adhesive tape dispenser, wherein the cutting opening that serves to cut off an adhesive tape contained in the adhesive tape dispenser has an end forming a pivotal joint holed seat that rotatably couples a cutter that also serves as a cover and that has a bottom from which an extension board extends to a middle portion of the cutting opening to define an enlarged slot, whereby after the adhesive tape is withdrawn from a rotatable support of the dispenser body and cut off by the cutter in the cutting opening, the adhesive tape may follow the closing operation of the cover for storage to be received into the hollow slot so as to meet the need of safety and practicability of operation of the adhesive tape dispenser.

### DESCRIPTION OF THE PRIOR ART

A regular adhesive tape dispenser is constructed to have a fixed base to be positioned on a desktop. A conventional portable adhesive tape dispenser is often of an open structure, which comprises a board based main body in a two-piece integrated configuration having a middle section connected with a flat board to thereby form a U-shaped structure after bending. The middle section flat board has an end forming integrated toothed cutting edge. Opposite surfaces of the U shape are respectively provided with halves of mated projection and recess fastening structure that forms a combined axle serving as a center of a roll of adhesive tape. The adhesive tape, after being unwound and withdrawn, is cut off by the cutting edge. Since the conventional portable adhesive tape dispenser has a side-open configuration and the cutting edge of cutting off the adhesive tape is exposed, the adhesive tape and the cutting edge are both not properly enclosed and protected and are easily susceptible to external contamination or staining with contaminants and may easily hurt a user by accident impact, so that it does not meet the need of safety and sanitary. A conventional portable adhesive tape dispenser that features complete enclosure and easy cutting operation is shown in FIGS. 9-11, body halves 30 that are mated for enclosure are provided for receiving and rotatably supporting a roll of adhesive tape body 31 and have a top forming a cutting opening 32 that has an end forming a pivotal joint holed seat 33 to allow direct pivotal joint of a cutting 34 made in the form of a cover from an outer side to cover the outside thereof. The bottom of the pivotal joint holed seat 33 forms an extension board 35 that has an opposite end defining a slot 36 for withdrawal of the adhesive tape, whereby the adhesive tape is housed inside the body 30 to provide a practical effect of safe portability and protection against contamination. In use, the cover-like cutter 34 is rotated outward to a properly inclined position and a leading end of the adhesive tape is withdrawn through the hollow slot 36 defined at one side of the cutting edge, so that the adhesive tape can be cut off by the cutting edge formed at the top end of the cutter 34 for subsequent use. Due to adhesion provided by the inner surface of the adhesive tape, the adhesive tape surface may directly adhere to the cutting edge at the same time when the adhesive tape is cut. After the use, the whole cutter 34 is collapsed by rotating to close, and the adhesive tape moves with the rotation in the downward direction to thereby outward bulge in a convex curved form, which makes it clamped outside the cutting opening 32. This not only affects operation safety of the closing and reception of the cutter 34, but also leads to safety and sanitary related problems in respect of the closing operation due to the exposure of the adhesive tape. To overcome such a problem, it often needs to use a finger to first push down a suspended segment of the adhesive tape that is in an inclined condition as shown in FIG. 12 in order to have the adhesive tape to be completely received in a space interposed between the extension board 35 and a closing inside surface of the cover formed by the cutter 34 to facilitate subsequent operation. Thus, the extension board 35 is structured to have a roughened surface to prevent over-adhesion between the surface and an adhesive surface of the adhesive tape, which often leads to inconvenience of the subsequent operation. Such an inconvenience that requires finger pushing down after application may cause practical concerns about sanitary and safety of use. Due to such a great inconvenience in the use thereof, a portable adhesive tape dispenser must be improved in respect of the enclosure and structure in order to meet the desired convenience of use and safety and sanitary for the reception of the adhesive tape.

### SUMMARY OF THE INVENTION

In view of the drawbacks of not suiting the needs of safety of continuous application and convenient operation in practical operation of cutting and reception of adhesive tape with the existing structure of conventional portable adhesive tape dispensers, the present invention aims to provide an adhesive tape dispenser having a cutting opening, wherein an extension board below a bottom of the cutting opening is extended to a middle portion of the cutting opening to define a properly enlarged slot to facilitate withdrawal and application of the adhesive tape and wherein when a cutter is closed for storage, the adhesive tape is moved in synchronization therewith to be received into the slot, whereby the various inconveniences and drawbacks of the existing adhesive tape dispensers in respect of reception and application thereof can be improved and overcome.

The primary objective of the present invention is to provide an adhesive tape dispenser that has a top forming a cutting opening and the cutting opening has a bottom that is connected to an extension board that extends to a middle portion of the cutting opening to thereby define an enlarged slot with which sanitary and safety of the adhesive tape realized by being enclosed can be achieved by the closing and storage of a cutter, whereby a convenient and practicable effect of synchronous safety is provided for application, cutting, and reception of the adhesive tape.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of an adhesive tape dispenser in accordance with an embodiment of the present invention.

FIG. 2 is a perspective view of the adhesive tape dispenser of the present invention in an assembled form.

FIG. 3 is a cross-sectional view illustrating use of the adhesive tape dispenser of the present invention in withdrawing and cutting adhesive tape.

FIG. 4 is a cross-sectional view illustrating reception and storage of the adhesive tape by using the adhesive tape dispenser of the present invention.

FIG. 5 is an exploded view of an adhesive tape dispenser in accordance with another embodiment of the present invention.

FIG. 6 is a perspective view of the adhesive tape dispenser of FIG. 5 in an assembled form.

FIG. 7 is a cross-sectional view illustrating use of the adhesive tape dispenser of FIG. 5 in withdrawing and cutting adhesive tape.

FIG. 8 is a cross-sectional view illustrating reception and storage of the adhesive tape by using the adhesive tape dispenser of FIG. 5.

FIG. 9 is a perspective view of a conventional portable adhesive tape dispenser.

FIG. 10 is a cross-sectional view illustrating reception of adhesive tape with the adhesive tape dispenser of FIG. 9 after the adhesive tape has been cut off.

FIG. 11 is a cross-sectional view illustrating a poor adhesion condition in the reception of the adhesive tape as shown in FIG. 10.

FIG. 12 is a cross-sectional view illustrating an operation of assisting curving of the adhesive tape for reception thereof with the adhesive tape dispenser of FIG. 9.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

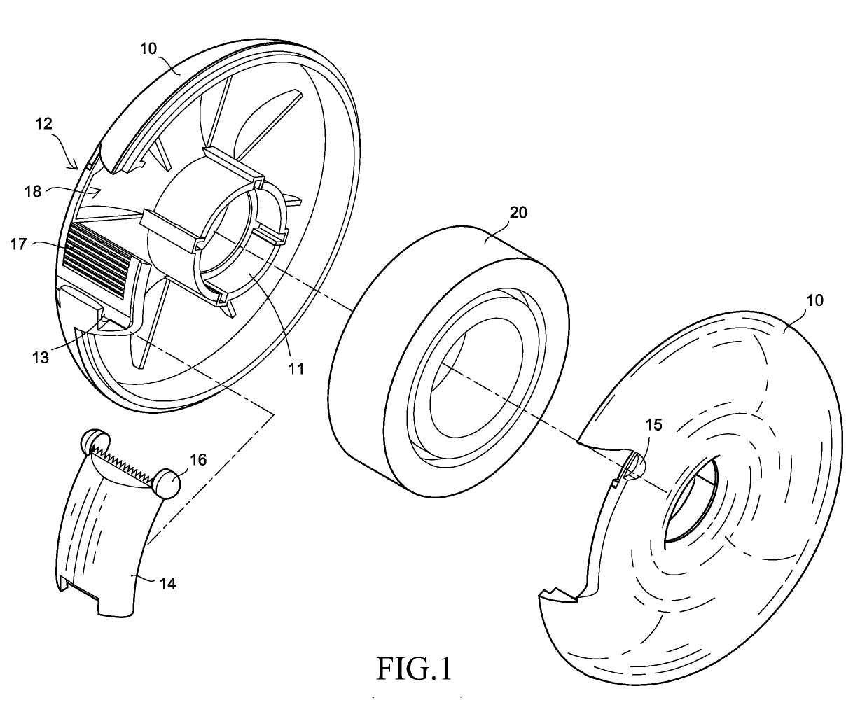

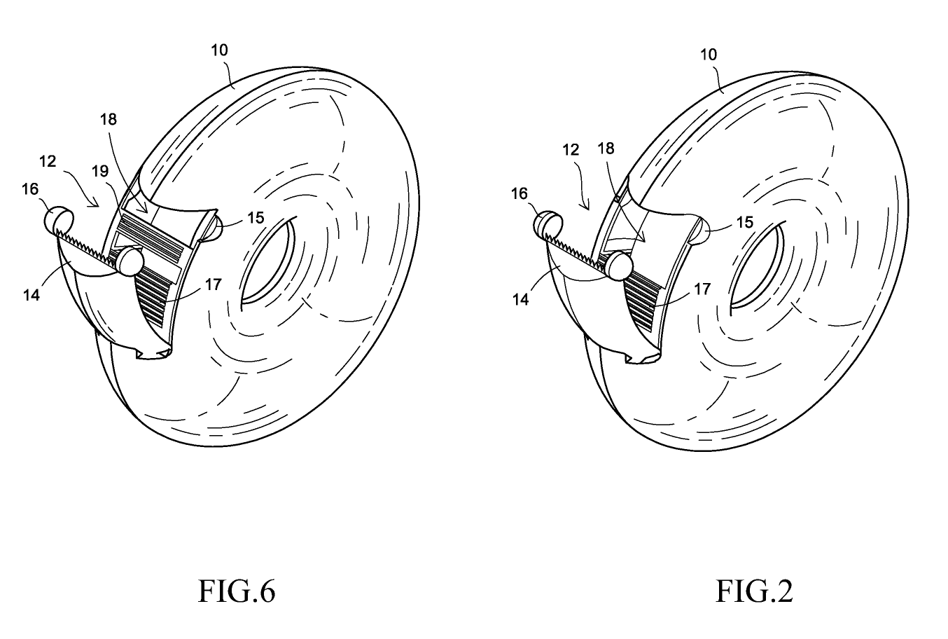

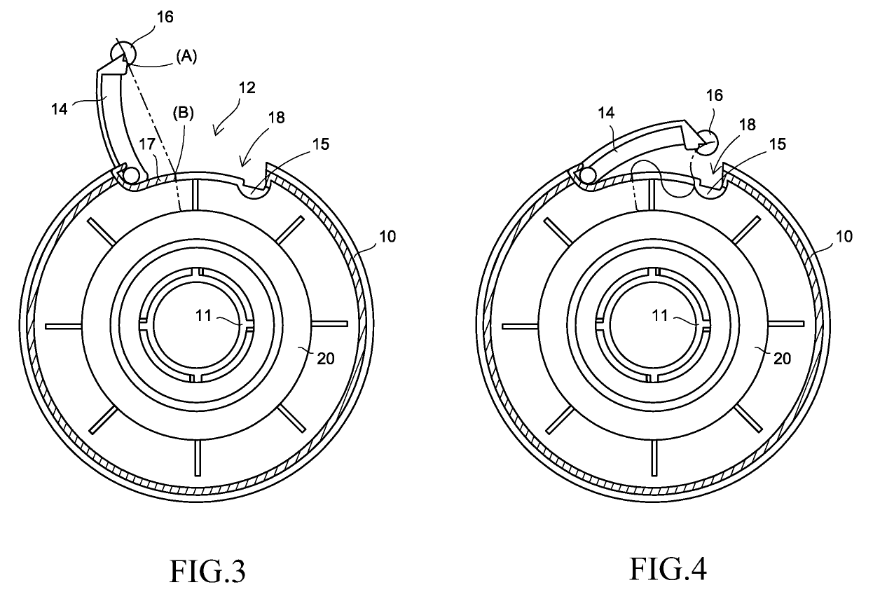

The present invention provides an adhesive tape dispenser having a cutting opening that is improved to allow un-dispensed adhesive tape to move with a tape cutter for easy storage after cutting of the tape has been performed. Referring to FIGS. 1-4, an adhesive tape dispenser of the present invention comprises a body 10, which is configured as an existing and currently available adhesive tape dispenser, and is made of plastics and structured to show an enclosing configuration. The body 10 comprises an assembly of nearly symmetric and opposite halves and forms internally projecting axle that can be mated together for coupling to fit through and support an adhesive tape body 20, preferably in the form of a roll. The improved feature of the present invention is that the body 10 forms, in a top thereof, a recessed cutting opening 12 having an end forming a pivotal joint holed seat 13 that rotatably receives and retains a cover cutter 14 for tape cutting, which is rotatable to close and cover the whole open space of the cutting opening 12. An opposite end of the cutting opening forms retention notches 15 on opposite sides of the body 10 for releasable engagements with retention pegs 16 that project sideways from opposite sides of the cutter 14 to realize retention and storage after being closed, whereby the recessed toothed cutting edge of the cutter 14 can be safely received and retained inside an inner surface of a circumferential wall of the body 10. The cutting opening 12 is provided with an extension board 17 that is formed on a bottom of the pivotal joint holed seat 13 and shows a curvature similar to the outer configuration of the body 10 and preferably forms a roughened surface. The board is extended to a middle portion of the cutting opening 12 to allow an end of the board to define an enlarged withdrawal slot 18 that facilitates easy assembling and withdrawal of the adhesive tape. After cutting of the adhesive tape, due to the force applied to perform the cutting, the portion of the adhesive tape that is not cut off is caused to adhere to a projecting flange surface A that is located below and close to the cutting edge and also adhere to a projecting end face B of the extension board 17, exhibiting a two point fixed connection surface. When the cutter 14 is rotated to close, due to a fixed length of the suspended segment of the adhesive tape that is formed by being adhered to the projecting flange surface A and the end face B, the suspended segment length of the adhesive tape will move with the closing motion of the cutter 14 and becomes naturally curved to be received in the hollow slot 18, thereby achieving a practical goal of operation of easy and safe reception. The length of the slot 18 is set to be at least 49% of the length of spacing between the fixed points A, B of the adhesive tape segment to facilitate safe and easy reception of the adhesive tape.

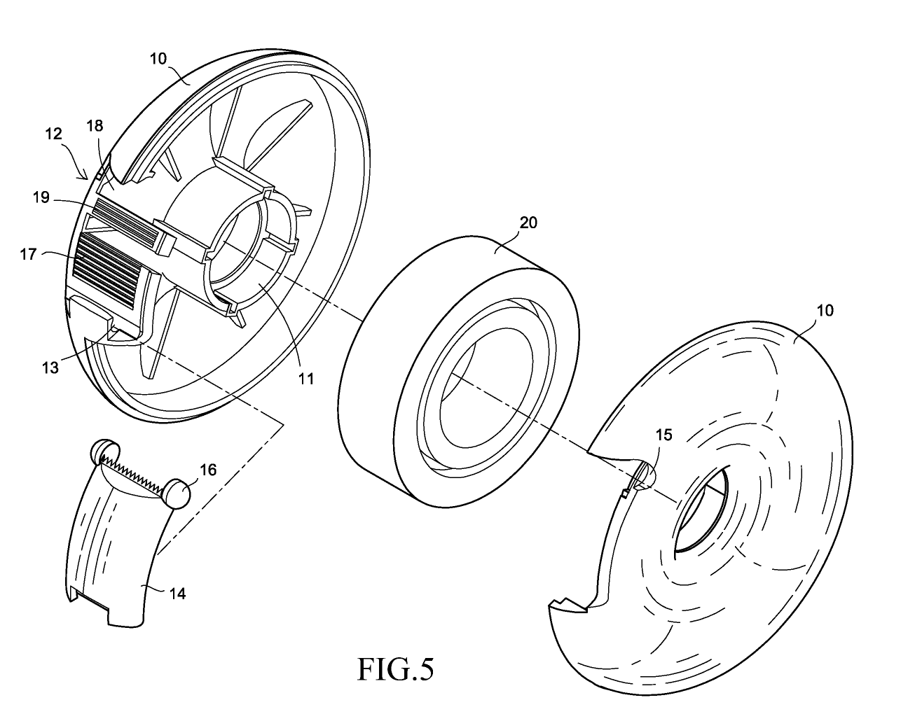

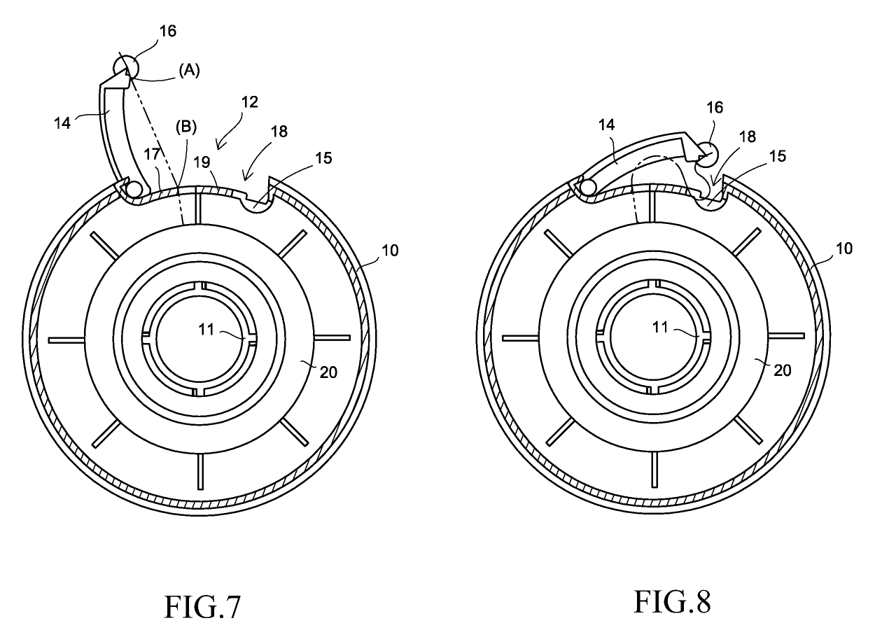

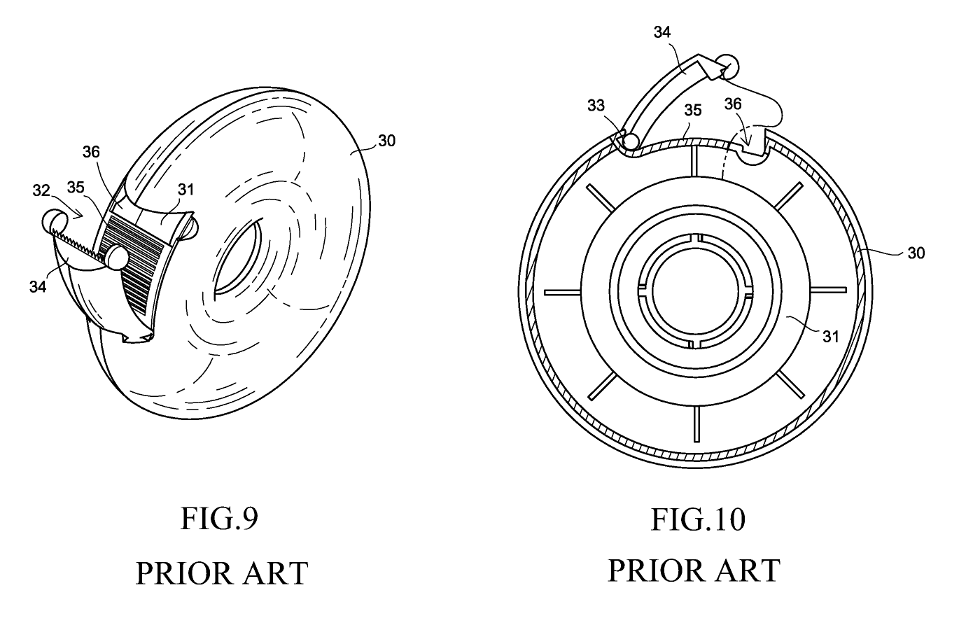

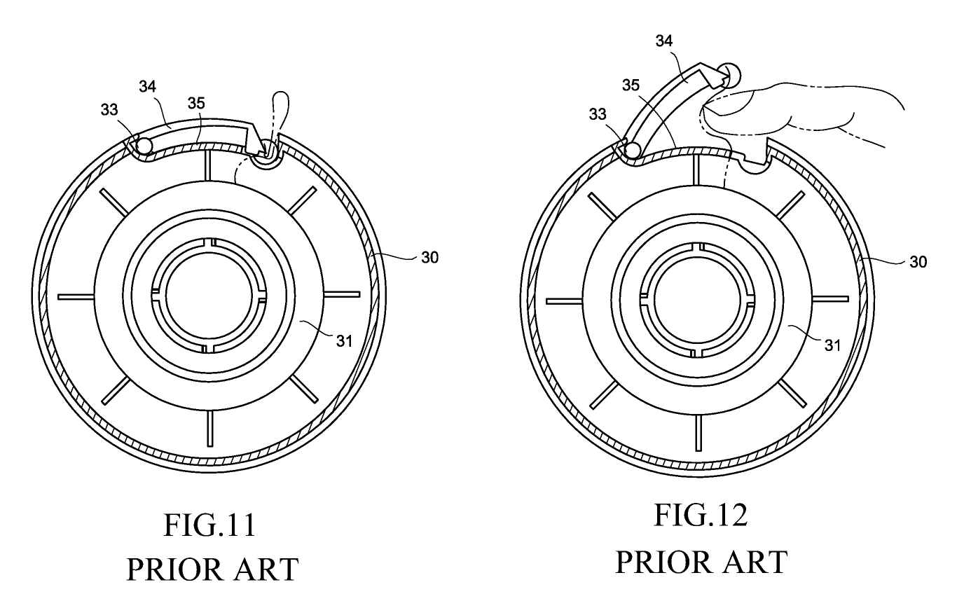

Besides being of a length greater than 49% of the connected segment of the adhesive tape length, to facilitate practical reception of the adhesive tape in a curved and guided manner, the reception slot 18 can be selectively modified to form a rack 19 at the end of the slot 18 adjacent to the extension board 17, as shown in FIGS. 5-8, which defines a proper spacing width with respect to the end of the extension board 17, whereby the adhesive tape can be withdrawn through the end of the extension board 17 for cutting off and after the cutting operation and the cutter 14 is closed, the curved segment of the adhesive tape to be received is brought into contact with and thus guided by the rack 19 to sequentially curved and set into the interior of the slot 18 for reception and storage. Due to contacting with and being guided by the rack 19, the segment of the adhesive tape may naturally assume a reception position in a form of an S-shape, so that the length of the curved segment that is received in the slot 18 is relatively shortened. This is particularly suitable for assembling a brand roll of adhesive tape body 20 for the segment of the adhesive tape that is received and an outer circumference of the adhesive tape body 20 do not interfere with each other due to the relatively small curved reception position, whereby a practical efficacy of making the withdrawal and reception position of the adhesive tape more smooth and safe is achieved, ensuring a safe, practical, and convenient operation of cutting and reception of the adhesive tape and making the portable adhesive dispenser meeting practical needs of sanitary and safe and convenient reception.

For the applications of the various embodiments of the present invention that illustrate cutting and reception of the adhesive tape, through controlling the extension length of the extension board 17 from the bottom of the pivotal joint holed seat 13 of the cutting opening 12, the slot 18 is made greater than 49% of the length of the connection surface of the segment of the adhesive tape between points A, B (a too small slot opening preventing the reception of the tape), whereby the adhesive tape segment may follow the closing of the cutter 14 onto the interior of the body 10 to be simply received in the hollow slot 18 of the cutting opening 12, so that the rotation of the cutter 14 is not interfered with and with the assistance provided by curving and guiding of tape realized by the rack 19 at a free end of the extension board 17, the reception and storage of the adhesive tape segment is made smooth. The rack 19 can be formed as a board or a rounded bar to serve as a banner against curving of the inner side of the received adhesive tape segment, so that the adhesive tape segment is forced to naturally form an S-shape of curve for reception, effectively shrinking a space that the adhesive tape swings and thus better suiting the need of safe reception. For all the variety of embodiments, the cutting opening is made to form an enlarged slot 18 to ensure a sufficient hollow space of the adhesive tape segment with respect to a curved surface of the cutter 14 when the adhesive tape segment is being withdrawn for cutting off (an excessively large slot affecting a handling space for withdrawal of the adhesive tape and thus making the withdrawal operation inconvenient), to facilitate the withdrawal of the adhesive tape and eliminate the problem of inconvenient withdrawal and cutting. Further, with the enlargement of the slot 18, the assembling and withdrawal of the adhesive tape body 20 are made convenient, without affecting the portability of the adhesive tape, but still maintaining the safe and sanitary of the adhesive tape in a received and enclosed form, helping preserving integral and aesthetic appearance of the adhesive tape dispenser and realizing the efficacy and purposes of safe and sanitary reception and use. The simple structure of the cutting opening and the synchronous reception of the adhesive tape that provided in accordance with the present invention have never been available in all types of portable adhesive tape dispensers and illustrate a novel creation in the structure of adhesive tape dispensers.

To summarize, the improved structure of the cutting opening of an adhesive tape dispenser in accordance with the present invention uses the enlarged slot that is provided inside the cutting opening and the arrangement of the extension board to simplify the assembling of the adhesive tape roll and also facilitate the withdrawal and cutting of the adhesive tape. Further, the present invention allows for a single hand operation of synchronously curving and receiving of the adhesive tape after the adhesive tape has been cut off, so as to ensure the practicability of safe and convenient withdrawal and reception of the adhesive tape.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An adhesive tape dispenser, comprising a combined pre-shaped dispenser body made of plastics for rotatably receiving and supporting a roll of adhesive tape body and forming in a top thereof a cutting opening for withdrawal and dispensing of the adhesive tape, a cutter being pivotally mounted to the dispenser body for selectively closing the cutting opening, characterized in that the cutting opening formed in the top of the dispenser body has an end forming a pivotal joint holed seat for pivotal joint of the cutter and an extension board located inside the cutting opening and extending from bottom of the pivotal joint holed seat to a middle portion of the cutting opening to define an enlarged slot that has a length greater than 49% of a segment of the adhesive tape that connects between a projecting flange surface located below a cutting edge of the cutter and an end face of the extension board, whereby the enlarged slot is formed inside the cutting opening for withdrawal of the adhesive tape and the adhesive tape, after being cut off, is movable with closing operation of the cutter to be curved and received into the slot so as to realize easy and safe reception of the adhesive tape.

2. The adhesive tape dispenser according to claim 1, wherein a rack is formed inside the slot defined by an end of the extension board extending within the cutting opening of the dispenser body in a spaced manner to provide assistance of curving and guiding the adhesive tape in the reception thereof so as to facilitate the reception of the adhesive tape.

3. The adhesive tape dispenser according to claim 1, wherein the extension board forms a roughened surface.

4. The adhesive tape dispenser according to claim 2, wherein the rack is made in the form of a board or a rounded bar.
